(19) United States
(12) Patent Application Publication
(10) Pub. No.: US 2014/0007115 A1
(43) Pub. Date: Jan. 2, 2014

(54) MULTI-MODAL BEHAVIOR AWARENESS FOR HUMAN NATURAL COMMAND CONTROL

(71) Applicants: Ning Lu, Saratoga, CA (US); Achintya K. Bhowmik, Cupertino, CA (US)

(72) Inventors: Ning Lu, Saratoga, CA (US); Achintya K. Bhowmik, Cupertino, CA (US)

(21) Appl. No.: 13/539,107

(22) Filed: Jun. 29, 2012

(51) Int. Cl. G06F 9/44

(52) U.S. Cl. 718/102

(57) ABSTRACT

A computer system is controlled using natural commands in multiple modes. In one example, a method includes receiving a first command in a first modality, receiving a second command in a second modality, determining whether the second command confirms the first command, and executing the first command if the second command confirms the first command.

### TECHNICAL FIELD

The present disclosure relates to controlling a computer system using natural commands and, in particular, to detecting human behavior in multiple modes as a command.

### BACKGROUND

Voice and gesture commands have been developed for man-machine interactions in a wide variety of fields. Software applications have been developed that recognize voice commands. The voice commands may be interpreted by a computer or more recently at a remote server which then provides a command back to the local device. A variety of systems have also been developed that recognize gesture commands. These have recently become commercially popular for gaming but have also been developed for presentation software and other purposes.

In using voice or gesture as a human machine interface, there is always a risk that a user may be talking to another person or even another machine but the machine interprets the human behavior as a command. For reliable operation, the computer should know when a command is really intended to be an order for the computer to execute or just part of a normal human activity. A spoken command may, for example, happen to be a part of a story someone is telling in a video conference call. To avoid the misinterpretation of a user command or gesture, some systems use a mechanism with which the user can address the machine. To indicate to the machine that the user intends a voice command, gesture, or other type of input some address or keyboard command is provided first.

To completely avoid misunderstood commands, machine operators can use keyboard and mouse devices. These allow commands to be precisely made and precisely directed to a particular machine. However, they are not natural for human interaction and are unintuitive In some systems that use gesture or voice commands, users constrain their behavior to adapt to the machine. For example, the user might insert a pronoun or a proper name as a subject before any command, such as calling “computer” before each command. This allows the computer to listen for its vocal address or name and avoid executing commands that are contained in a normal conversation or presentation. Another approach is to ask the user to hold a gesture for a prolonged time. This is an abnormal gesture so the computer will not confuse it with other normal gestures. These approaches require the user to do something out of the ordinary to distinguish the computer command from normal human actions. As a result, the out of the ordinary action or words, make the computer interaction feel unnatural and unintuitive.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram a hardware implementation of the present invention according to a first embodiment of the invention.

FIG. 2 is a block diagram a hardware implementation of the present invention according to a second embodiment of the invention.

FIG. 3 is a process flow diagram for confirming a first command using a second command according to an embodiment of the invention.

FIG. 4 is a block diagram of a computer system suitable for implementing processes of the present disclosure according to an embodiment of the invention.

### DETAILED DESCRIPTION

In some examples described below, the computer combines multiple modalities together so that the computer has a better and more accurate basis to determine when a user intends a statement or a gesture to be a command for the computer. This may cause the system to adapt to the users instead of letting users adapt to the system. As a result, the entire man-machine interface experience is more natural and intuitive to the user. In one example this can be done using a user intention awareness component that filters out the unintended signals that may appear to the computer as command signals but are not.

Embodiments of the present invention may be applied to any keyboardless PC (Personal Computer) design or keyboardless user interface design that uses a camera as the main input device, and in which navigation or application commands are controlled by multiple modalities. It may also be applied to any PC design that involves a multi-tier power-on strategy from the perspective of user awareness. While embodiments are described in the context of a PC, the described embodiments may be applied to any device that receives user commands including a computer, a presentation system, or an entertainment system.

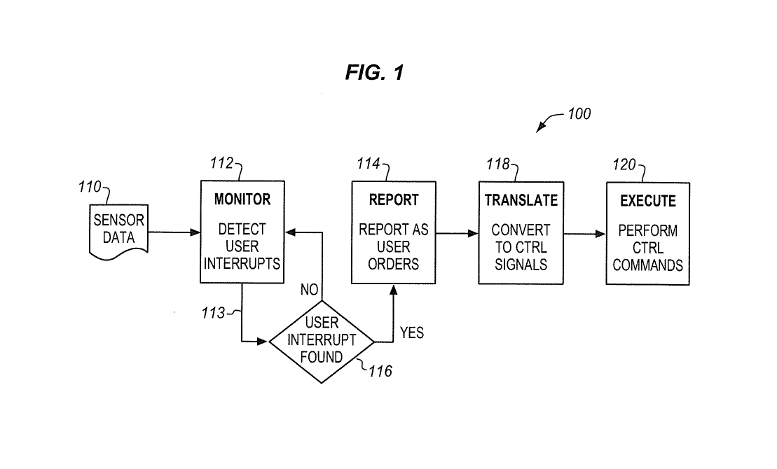

A command structure typically has several layers of operation. As shown in FIG. 1, a command structure system 100 has some type of sensor 110, typically a keyboard, mouse, touch pad, or touch screen. In addition, cameras and microphones may also be used. The sensor is monitored for a command by a monitor 112. In some cases, the sensor generates an interrupt 113 that is forwarded to an interrupt detector 116. The monitor 112 monitors the environment continuously and constantly or at intervals through the sensor 110. It generates different types of warning or interrupt signals based on the type of sensor. For a keyboard, there are different signals for different keys. For a touch pad, there may be different levels for different levels of pressure and speed. In other cases the sensor may be a capacitance or resistance measuring circuit, a water level meter, a thermometer, a hygrometer, a mass spectrometer, etc.

At a report level, if a monitored sensor generates an event, such a response to a polling signal or an interrupt, then this is detected 116 and indicated to a report system 114. The report level processes the monitored signals and generates the corresponding commands. In the case of a PC, the striking of a particular key is interpreted as a letter or a command symbol. A translator 118 receives the report and translates those orders into actionable control signals. Command control 120 then performs or executes the desired action according to the nature of the command and the configuration of the particular system.

This system 100 allows a usage scenario in which, for example, the user is typing a document. The user then uses a voice command to edit the document by saying “delete last word” or “move the cursor back two lines”. This can greatly improve the convenience of using the system. Such a structure monitors 112 the single sensor 110 for a command. The system has a single modality, either keyboard-and-mouse, or touch screen, or gesture, or voice, etc. Some systems may allow different modalities to be used as alternates. As a result, there is a risk that a command may be misunderstood or something that is not intended as a command may be interpreted as a command. This can be avoided using a combination of modalities. Additional modalities may be supported by coupling additional sensors to the monitor 112 or by repeating the command structure system to support each additional sensor type.

A combination of modalities allows the system to eliminate the execution of unintended command orders. A simple usage example of multiple modalities can be considered in the context of presenting a slide show or mixed media presentation. Rather than just stating “next slide”, the user can combine, for example, a rolling hand gesture with the phrase “next slide.” Hand gestures, for example, are easy to perform and prevent the presentation system from changing slides when that is not intended. In this case, the hand rolling gesture may be a common natural gesture used during the presentation or during normal conversation. Similarly, the phrase “next slide” may be used when discussing the slides without intending the displayed slide to be changed to the next slide. By requiring both the gesture and the statement to be made at about the same time, the system allows the user to easily move to the next slide with very little chance of misunderstanding.

Another use scenario also combines a microphone to receive a spoken command with a camera to observe the operator. For any application, a user may tell the computer “Close the window!.” This may be a command to the computer, but it may instead be spoken to someone in the room who is near an open window. The camera can be used for face detection. The camera can be used to make sure that the speaker is looking at a computer screen with an open window instead of looking away at another part of the room or to a different window on another monitor. The camera may be used not only for direction of attention but also to make sure that the person looking at the computer screen was also talking when the “close the window” audio was received.

In addition to using more than one modality, the system may further ensure a command was issued using confirmation. In the example above, two different sensor modes are combined to ensure that a command is issued. The sensors, microphones and cameras are always active in a typical system. As an alternative, a confirmation can be used that is activated after a candidate command control is signaled.

The confirmations may be implicit or explicit. The implicit confirmation gets information about an active intention of the user without requiring any specific action from the user. The “close the window” example may be viewed in this way. If the active intention confirmation fails, then the application that received the command may have an option to discard the command. Alternatively, other implicit confirmations or initiated explicit confirmations may be used.

An explicit confirmation requires some action from the user. An example of such an explicit confirmation is a prompt initiated by the system to confirm the command. A simple example would be for the system to present a yes or no question. As an example, the computer can generate an audio signal to repeat the command that it inferred from the user statement. In such a case, the computer states, “Do you really want to close the current window?” If the user answers yes, then the command is confirmed. A smart implementation using implicit and explicit confirmation of the user's intention avoids intruding on the user experience and also eliminates a user's frustration with unintended command being executed.

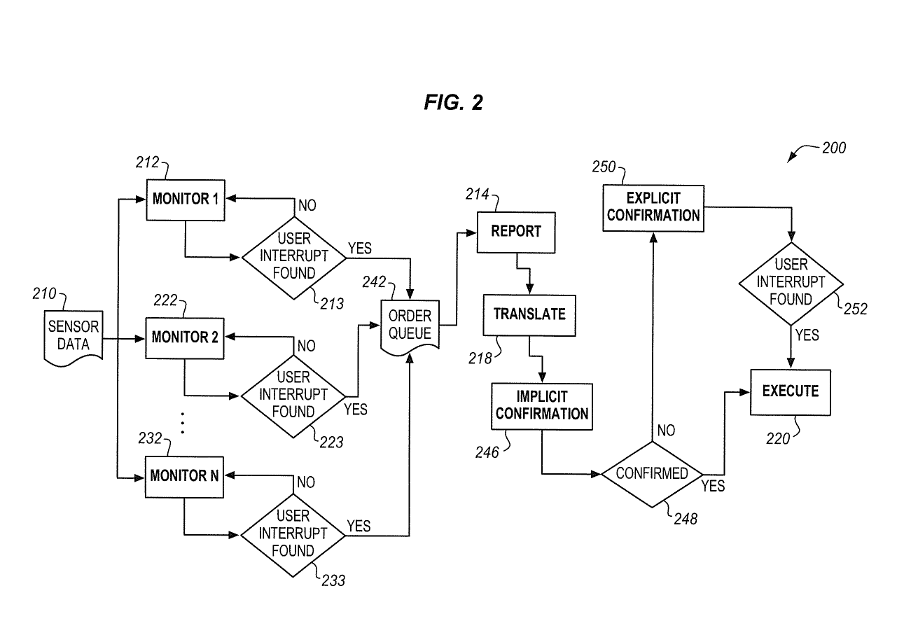

FIG. 2 shows an example of a command structure system 200 in which observed commands in one modality may be confirmed by observed commands in another modality. At 210 one or more sensors are used to detect speech gestures, eye tracking, and other types of command input in one or more modalities. The sensor data is applied to monitors 212, 222, 232. Each of the monitors is shown as coupled to the same sensor data, however, different sensor data may be dedicated to each monitor, depending on the particular implementation.

Each monitor provides an output to a decision block 213, 223, 233 which looks to see whether the monitor has produced an interrupt. When an interrupt is found, then the interrupt is fed into a queue 242 which feeds it to a report module 214. The order queue orders the interrupts based on when they were generated. In some implementations, the order queue may order some types of interrupts ahead of other types of interrupts, so that these interrupts receive faster attention. For example keyboard input may be provided with a higher priority. For a system, as described above, in which commands are provided in different modalities, the modalities that are used first may be accorded a higher priority. If the system is configured to receive a vocal or speech command “next slide” accompanied by a hand gesture, then the microphone sensor can be ordered first. In this way the system is ready for the confirmation of the hand gesture when it receives the interrupt for the hand gesture. Alternatively, the decision block may be incorporated into the monitors or into the order queue.

The order queue sends the interrupts in a particular order to a report module 214. The report module receives the interrupts and processes the interrupts to generate commands to the system. The speech command “next slide” is converted into a command into the presentation program to move to the next slide in the same way that a page down, down arrow, or mouse press would be. The report module supplies the command to a translator 218 which translates this higher level command into a control signal.

The control signal then triggers an implicit confirmation module 246. Just as the speech command “next slide” has been reported and translated, the accompanying hand gesture also will result in an interrupt to the order cue, and command from the report module and then a corresponding control signal from the translator. Implicit confirmation, upon receiving “next slide” will wait until it receives the hand gesture. If it receives this implicit confirmation, then at 248, the “next slide” control signal is provided to command control 220 for execution. The implicit confirmation module 246, accordingly, interrupts the execution of received commands until it receives the confirmation of the those commands.

If the implicit confirmation module 246 does not receive the implicit confirmation, then the first command, or the command in the first modality is sent to an explicit confirmation module 250. The confirmation decision may be timed. In other words, there may be a timer (not shown) for implicit confirmation so that the confirmation must be received within a selected time interval or the command is either rejected or sent to the explicit confirmation module 250. For two modalities that would be provided at almost the same time, the time interval may be very short, perhaps less than a second. For two modalities that are performed by the user in a particular sequence then a few seconds might be provided.

The explicit confirmation module 250 will provide a prompt to the user, such as a video or screen prompt or an audio prompt. The explicit confirmation module 250 will then wait for a reply to be detected at a sensor 210, sent through a monitor 212, and fed through report, translate, and monitor stages to be received at the explicit confirmation module 250. If the explicit confirmation is received 252, then the command in the first modality is provided as a control signal for execution 220. Otherwise the command is rejected. The user may find that the intended command has not been executed and may then try again. More frequently, however, a user action that was not intended to be a command will be discarded by the system and not executed as a command. This provides a better overall user experience.

While a spoken command “next slide” and a hand gesture is used as an example, any of the other examples provided herein may be handled in the same or a similar way. As an example, the user may make a wave hand gesture for “next page” observed by the camera and then the system will look for implicit confirmation using the camera for eye tracking. If no implicit confirmation is received, then the system may provide a prompt on the display such as “Did you mean next page? If so hold up one finger.” The camera monitor will then look for the one finger for explicit confirmation. A wide variety of different command combinations may be used depending on the particular implementation and the intended use for the system.

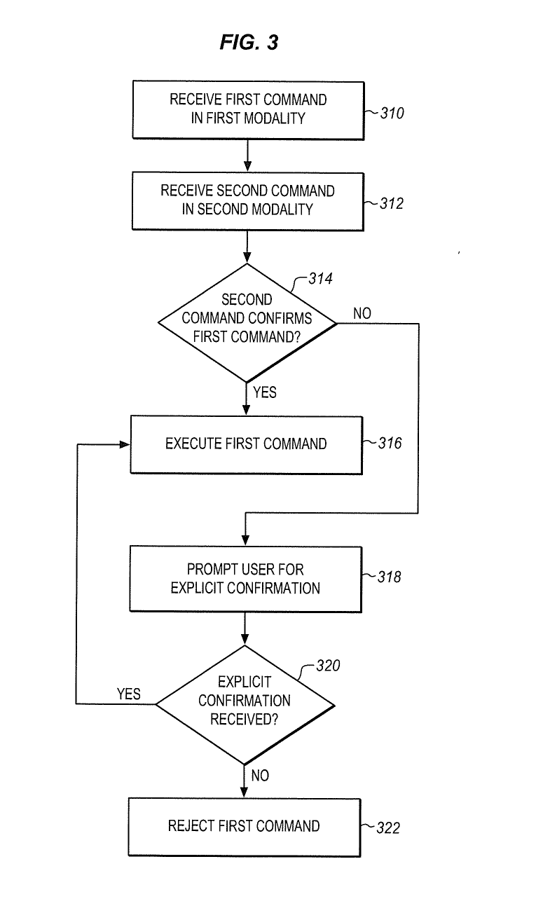

FIG. 3 is a process flow diagram of the operations performed by the systems 100, 200 described above. This process flow may be repeated for every received command and for the interpretation of each command. At 310, a first command is received in a first modality. As mentioned above, the command may be a vocal command, a gesture, an activation of a peripheral device or any of a variety of other command modalities. The command may be detected by a microphone, camera, or any other user input device. At 312 a second command is received in a second modality.

At 314, it is determined whether the second command confirms the first command. If not then the user is prompted for explicit confirmation at 318 or, in another embodiment at 322, the first command is rejected. Alternatively, the second command may be unrelated to the first command but instead another first command that requires confirmation.

There are a variety of different ways to assess the first and second commands. In one example, the system has a list of approved commands and their associated approved confirmations. The list may be accessed upon or after receiving the first command. The received first command may then be used to determine how the first command may be confirmed. The received second command may then be compared to the accessed list of approved command confirmations. If there is a match with a confirmation on the list, then the first command is executed at 316. If the received second command does not match with an approved confirmation, then it may be applied to the list as a first command to see if it has been confirmed by a later received command

Alternatively, if the second command is not determined to be an approved command confirmation at 314, then at 318, the user is prompted for explicit confirmation of the first command. If an explicit confirmation is received from the user in response to the prompt at 320, then the first command is executed at 316. If there is neither an implicit, nor an explicit confirmation, then the first command is rejected 322.

As shown in FIG. 3, the system uses commands in different modalities to confirm the user's intention, before executing the command. This provides a more natural feel to the commands than requiring two commands in the same modality. The command in the first modality, for example, may be a spoken command and the command in the second modality may be a hand gesture. This corresponds to the example of saying “next slide” accompanied by a hand gesture. In such a case, the first modality is speech and the second modality of the second command is an observed behavior of the user. A similar example is to say “next page” with a waving hand gesture or to say “next page” while looking at the monitor. In another example, the first modality is a hand gesture and the second modality is a response to a prompt.

The prompt may be a visual prompt from the system or an audio prompt from the system or any of a variety of other prompts. An explicit confirmation in response to a prompt may be a spoken command, a gesture, the operation of a user input peripheral or any other desired response. The response may be suggested by the prompt as in the examples above or it may be understood from the nature of the prompt.

Note that while FIG. 3 might suggest that the first command is received before the second command, the second command may be received before the first command. The commands may be first and second in timing, but in this example they are first and second in priority. The first command is the primary command because it indicates the command that is to be executed. The second command is secondary because it confirms the first command. In the example of saying “next slide” with a hand gesture, the user may start the gesture and even complete the gesture before saying “next slide.” The system would feel more natural if either the speech or the gesture can be provided first and the same result would occur. In such an implementation, it is not important which is done or completed first, but only that both commands are received.

To increase the accuracy of the system and, accordingly, improve the user experience, a weighting system may be used to analyze received commands. In the examples above, commands are measured using binary decisions for each modality. Command control using a weighting system may be used to cut the threshold only on the final step or at other steps in the process, depending on the implementation.

In each case there will be some number of different modalities, N, for each one modality n. Two state parameters can be assigned:

P(n,0) is the probability that the particular modality n is not detected. No command has been received. In other words, this is the probability of modality n having the state 0.

P(n,1) is the probability that the modality n is associated with command control and is fully detected. A command has been received. In other words, the probability of modality n having the state 1.

The probabilities are predefined for each command. So the overall probability P(T) of a command being received at any moment T may be given as

P(T)=Πₙ₋₁^{N}{P(n,0)+p(n)*(P(n,1)−P(n,0))},

Where p(n) is the probability of the n-th modality associated with the command control detected at the time interval T−ΔT(n) and T, and where ΔT(n) is the time interval allowed for the n-th modality to be considered active. An inactive n-th modality will have P(n,0)=P(n,1)=1. (1 means no probability). The probabilities measured within time intervals allows a confirmation of a command to be limited to within a particular time interval ΔT(n). If a command confirmation is received too late after the initial time, T, then the initial command is rejected.

To use multiple modalities as alternatives to each other:

set P(n,0)=1/K and P(n,1)=K^{N-1} for all n, for some large number K.

To use multiple modalities together to make sure they confirm with each other:

set P(n,0)=0 and P(n,1)=1 for all n.

The natural human-machine interface described above may be implemented using a wide variety of different machines including computers, presentation systems and personal media devices. It combines multiple input sources, including but not limited to gestures, speech, and emotion, and derives meaningful input signals from these sources. Each source allows commands to be presented in more than one modality. In some embodiments, it utilizes a connected display device as an inseparable part of the input process for more reliable input. The display can present prompts and confirmations for targeted usages.

In many implementations, the user does not need to be physically within a reachable distance to any part of the system's peripherals once the system is on. By using voice and gestures as input, keyboard and pointing devices can be left a distance away. This can be enabled using a dedicated human behavior awareness component to manage and configure all input sensors to serve all applications. For even more responsiveness and accuracy, a weighted method can be used to combine multiple modalities.

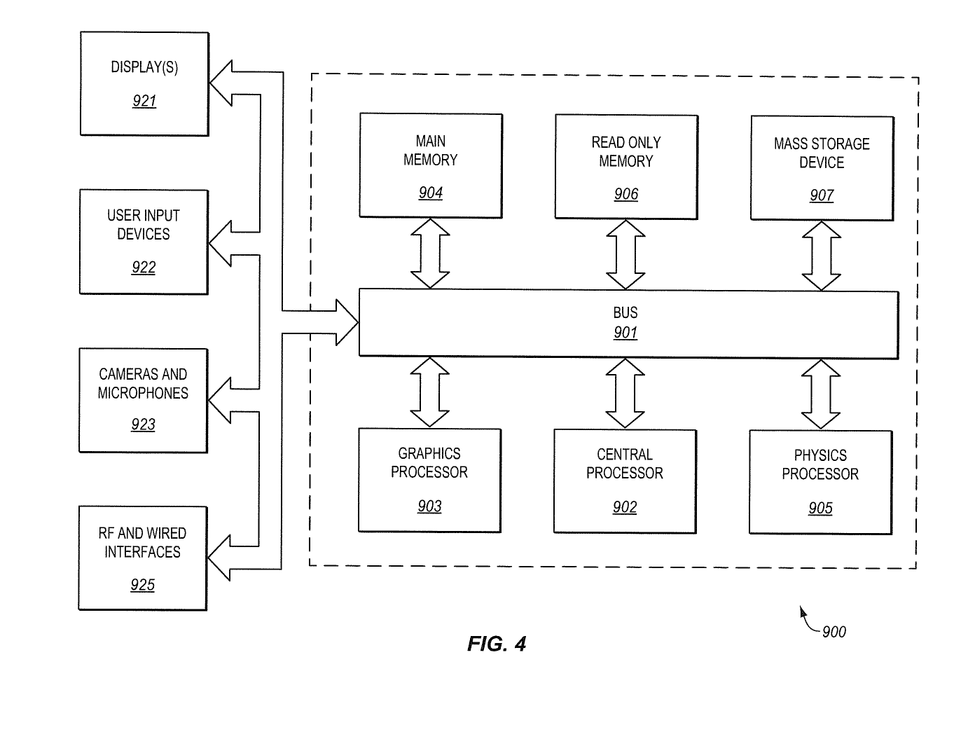

FIG. 4 is a block diagram of a computing system, such as a personal computer, gaming console, smart phone or portable gaming device. Computer system 900 may refer to a many examples of an electronic device and may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof.

The computer system 900 includes a bus or other communication means 901 for communicating information, and a processing means such as a microprocessor 902 coupled with the bus 901 for processing information. In the illustrated example, processing devices are shown within the dotted line, while communications interfaces are shown outside the dotted line, however the particular configuration of components may be adapted to suit different applications. The computer system may be augmented with a graphics processor 903 specifically for rendering graphics through parallel pipelines and a physics processor 905 for calculating physics interactions as described above. These processors may be incorporated into the central processor 902 or provided as one or more separate processors. The computer system 900 further includes a main memory 904, such as a random access memory (RAM) or other dynamic data storage device, coupled to the bus 901 for storing information and instructions to be executed by the processor 902. The main memory also may be used for storing temporary variables or other intermediate information during execution of instructions by the processor. The computer system may also include a nonvolatile memory 906, such as a read only memory (ROM) or other static data storage device coupled to the bus for storing static information and instructions for the processor.

A mass memory 907 such as a magnetic disk, optical disc, or solid state array and its corresponding drive may also be coupled to the bus of the computer system for storing information and instructions. The computer system can also be coupled via the bus to a display device or monitor 921, such as a Liquid Crystal Display (LCD) or Organic Light Emitting Diode (OLED) array, for displaying information to a user. For example, graphical and textual indications of installation status, operations status and other information may be presented to the user on the display device, in addition to the various views and user interactions discussed above.

Typically, user input devices 922, such as a keyboard with alphanumeric, function and other keys, may be coupled to the bus for communicating information and command selections to the processor. Additional user input devices may include a cursor control input device such as a mouse, a trackball, a trackpad, or cursor direction keys can be coupled to the bus for communicating direction information and command selections to the processor and to control cursor movement on the display 921.

Camera and microphone arrays 923 are coupled to the bus to observe gestures, record audio and video and to receive visual and audio commands as described above.

Communications interfaces 925 are also coupled to the bus 901. The communication interfaces may include a modem, a network interface card, or other well known interface devices, such as those used for coupling to Ethernet, token ring, or other types of physical wired or wireless attachments for purposes of providing a communication link to support a local or wide area network (LAN or WAN), for example. In this manner, the computer system may also be coupled to a number of peripheral devices, other clients, control surfaces or consoles, or servers via a conventional network infrastructure, including an Intranet or the Internet, for example.

A lesser or more equipped system than the example described above may be preferred for certain implementations. Therefore, the configuration of the exemplary systems 900 will vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following examples pertain to further embodiments. Specifics in the examples may be used anywhere in one or more embodiments. In one embodiment, a method includes receiving a first command in a first modality, receiving a second command in a second modality, determining whether the second command confirms the first command, and executing the first command if the second command confirms the first command.

In a further embodiment the second command is at least one of an observed behavior of the user, in response to a visual prompt from the system, in response to an audio prompt from the system, and received before the first command.

In a further embodiment, the first modality is of a spoken command and the second modality is a hand gesture, or the first modality is a hand gesture and the second modality is a response to a prompt. The response to the prompt may be a spoken command.

In a further embodiment, the method also includes accessing a list of approved command confirmations after receiving the first command, comparing the received second command to the accessed list of approved command confirmations, and executing the first command if the second command is determined to be an approved command confirmation based on the comparison.

The method may also include prompting the user for explicit confirmation of the first command if the second command is not determined to be an approved command confirmation.

The method may also include executing the first command if an explicit confirmation is received from a user in response to the prompt.

In another embodiment a non-transitory computer-readable medium has instructions that, when operated on by the computer, cause the computer to perform operations that include receiving a first command in a first modality, receiving a second command in a second modality, determining whether the second command confirms the first command, and executing the first command if the second command confirms the first command.

In a further embodiment the second command is in response to at least one of a visual and audio prompt from the system.

In a further embodiment the operations also include accessing a list of approved command confirmations after receiving the first command, comparing the received second command to the accessed list of approved command confirmations, and executing the first command if the second command is determined to be an approved command confirmation based on the comparison.

In a further embodiment, the operations also include prompting the user for explicit confirmation of the first command if the second command is not determined to be an approved command confirmation, and executing the first command if an explicit confirmation is received from a user in response to the prompt.

In another embodiment, an apparatus includes a first monitor to receive a first command in a first modality, a second monitor to receive a second command in a second modality, and a processor to determine whether the second command confirms the first command and to execute the first command if the second command confirms the first command.

In a further embodiment the first monitor is coupled to a microphone and the first modality is a spoken command from the user. The second monitor is coupled to a camera and the second modality is a visual modality comprising at least one of a gesture, eye tracking, and a hand signal.

In a further embodiment, the apparatus includes a display to present a visual prompt to the user in response to the first command, the prompt being to prompt the user to provide the second command. Additionally, the prompt may be a question presented to the user on the display.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method comprising:
receiving a first command in a first modality;
receiving a second command in a second modality;
determining whether the second command confirms the first command; and
executing the first command if the second command confirms the first command.

2. The method of claim 1, wherein the second command is an observed behavior of the user.

3. The method of claim 1, wherein the second command is in response to a visual prompt from the system.

4. The method of claim 1, wherein the second command is in response to an audio prompt from the system.

5. The method of claim 1, wherein the second command is received before the first command.

6. The method of claim 1, wherein the first modality is a spoken command and the second modality is a hand gesture.

7. The method of claim 1, wherein the first modality is a hand gesture and the second modality is a response to a prompt.

8. The method of claim 7, wherein the response to the prompt is a spoken command.

9. The method of claim 1, further comprising:
accessing a list of approved command confirmations after receiving the first command;
comparing the received second command to the accessed list of approved command confirmations; and
executing the first command if the second command is determined to be an approved command confirmation based on the comparison.

10. The method of claim 9, further comprising prompting the user for explicit confirmation of the first command if the second command is not determined to be an approved command confirmation.

11. The method of claim 10, further comprising executing the first command if an explicit confirmation is received from a user in response to the prompt.

12. An article including a non-transitory computer-readable medium having instructions that, when operated on by the computer, cause the computer to perform operations comprising:
receiving a first command in a first modality;
receiving a second command in a second modality;
determining whether the second command confirms the first command; and
executing the first command if the second command confirms the first command.

13. The medium of claim 12, wherein the second command is in response to at least one of a visual and audio prompt from the system.

14. The medium of claim 12, the operations further comprising:
accessing a list of approved command confirmations after receiving the first command;
comparing the received second command to the accessed list of approved command confirmations; and
executing the first command if the second command is determined to be an approved command confirmation based on the comparison.

15. The medium of claim 14, the operations further comprising:
prompting the user for explicit confirmation of the first command if the second command is not determined to be an approved command confirmation; and
executing the first command if an explicit confirmation is received from a user in response to the prompt.

16. An apparatus comprising:
a first monitor to receive a first command in a first modality;
a second monitor to receive a second command in a second modality; and
a processor to determine whether the second command confirms the first command and to execute the first command if the second command confirms the first command.

17. The apparatus of claim 16, wherein the first monitor is coupled to a microphone and wherein the first modality is a spoken command from the user.

18. The apparatus of claim 16, wherein the second monitor is coupled to a camera and wherein the second modality is a visual modality comprising at least one of a gesture, eye tracking, and a hand signal.

19. The apparatus of claim 16, further comprising a display to present a visual prompt to the user in response to the first command, the prompt being to prompt the user to provide the second command.

20. The apparatus of claim 19, wherein the prompt is a question presented to the user on the display.
